(19) United States
(12) Patent Application Publication
(10) Pub. No.: US 2017/0040798 A1
(43) Pub. Date: Feb. 9, 2017

(54) Controlling a Load and an Energy Source Based on Future Energy Level Determinations

(71) Applicant: QUALCOMM Incorporated, San Diego, CA (US)

(72) Inventors: Santiago Mazuelas, San Diego, CA (US); Peerapol Tinnakornsrisuphap, San Diego, CA (US); Shengbo Chen, San Diego, CA (US)

(21) Appl. No.: 15/062,451

(22) Filed: Mar. 7, 2016

Related U.S. Application Data
(60) Provisional application No. 62/202,678, filed on Aug. 7, 2015.

(51) Int. Cl. H02J 3/00; G05F 1/66

(52) U.S. Cl. CPC H02J 3/00; G05F 1/66

(57) ABSTRACT

Described in this disclosure are embodiments for controlling a load and an energy source associated with an entity. A system may determine a first energy level, along with variability for the first energy level, associated with the entity for a first period (e.g., prior to a present time). The system may further determine a contextual data, along with variability for the contextual data, associated with the entity for a second period (e.g., after the present time). The first and second energy levels may be received from one or more control devices in communication with the system. The system may determine a second energy level associated with the entity for the second period. The second energy level may be based at least partly on the first energy level and the contextual data. The system may control, based at least partly on the second energy level, the load and the energy source.

### CROSS-REFERENCE TO RELATED APPLICATIONS

The present application claims priority to U.S. Provisional Application No. 62/202,678, filed Aug. 7, 2015, titled “Controlling a load and an energy source based on future energy level determinations,” the entirety of which is incorporated by reference into this disclosure.

### TECHNICAL FIELD

The present application generally relates to energy management for an entity.

### BACKGROUND

An entity (e.g., a house, an office, a car, etc.) is associated with various energy consumption activities. Additionally, the entity may also be associated with an energy source. Some of these energy consumption activities consume more energy than others, and some of these activities may compete with each other for obtaining energy from the energy source. This may lead to a situation where some activities may not be able to access the amount of energy they require from the energy source, or a situation where the energy source is depleted and alternate energy sources are expensive. Therefore, there is a need to manage the energy source and energy consumption activities to reduce the frequency of such situations.

### SUMMARY

Described in this disclosure are various embodiments of controlling a load and an energy source associated with an entity (e.g., a house, an office, a car, etc.). An energy management system, also referred as the system, may receive a first energy consumption level for the load from a first control device, and receive a first energy generation level for the energy source from a second control device. The system may determine a first energy level, along with a variability for the first energy level, associated with the entity for a first period (e.g., prior to a present time). The first energy level may be based at least partly on the first energy consumption level for the load and the first energy generation level for the energy source. The system may further determine contextual data, along with variability for the contextual data, associated with the entity for a second period (e.g., after the present time). The system may further determine a second energy level associated with the entity for the second period. The second energy level may be based at least partly on the first energy level and the contextual data. The second energy level may comprise a second energy consumption level for the load and a second energy generation level for the energy source. The system may control the load based at least partly on the second energy level or the second energy consumption level. Additionally or alternatively, the system may control the energy source based at least partly on the second energy level or the second energy generation level. Controlling the load may comprise activating or deactivating the load for a first predetermined period, and controlling the energy source may comprise activating or deactivating the energy source for a second predetermined period.

In some embodiments, the system may receive, from a third control device, a first energy storage level for an energy storage associated with the entity. The first energy level associated with the entity may be based at least partly on the first energy storage level for the energy storage. Additionally, the system may control the energy storage based at least partly on the second energy level associated with the entity. Controlling the energy storage may comprise activating (e.g., charging) or deactivating (e.g., discharging) the energy storage for a predetermined period. In some embodiments, the system may control the energy storage or schedule operation of the load based on predicting an energy consumption level for the load and/or predicting an energy generation level for the energy source. In some embodiments, the system may select among various schedules for operating the load and/or controlling the energy storage based on determining a cost associated with each schedule.

In some embodiments, the system may determine the contextual data based at least partly on monitoring entity data associated with the entity during the first period. In some embodiments, the entity data may comprise a weather forecast for an area associated with the entity, a number of occupants in the entity, energy-related activities of the occupants in the entity, a type, cost, and usage of loads associated with the entity, a type, cost, and usage of energy sources associated with the entity, a type, cost, and usage of energy storages associated with the entity, etc.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 presents an environment for performing energy management for an entity, in accordance with some embodiments of the disclosure;

FIG. 2 presents a method for controlling a load and an energy source associated with the entity, in accordance with some embodiments of the disclosure;

FIG. 3 presents charts associated with energy management for the entity, in accordance with some embodiments of the disclosure; and

FIG. 4 presents a method for selecting among schedules for operating a load and an energy storage associated with the entity, in accordance with some embodiments of the disclosure.

Although similar reference numbers may be used to refer to similar elements for convenience, it can be appreciated that each of the various example implementations may be considered distinct variations.

### DETAILED DESCRIPTION

Embodiments of the present disclosure are directed to predicting energy consumption and energy generation for an entity (e.g., a house, an office, a car, etc.). Such predictions may be used to schedule certain energy-related activities for the entity. For example, an energy storage (e.g., a battery) may be charged during a period when an energy generation level of an energy source (e.g., a solar panel) associated with the entity is higher than an energy consumption level for the entity. As a further example, the energy storage may be charged using energy derived from a grid during a certain period when a cost of energy derived from the grid is lower than the cost of energy derived from the grid during other periods. As a further example, the energy storage may be discharged to supply energy to and operate loads of an entity during a certain period when the cost of energy derived from the grid is equal to or greater than the cost of energy derived from the grid during other periods.

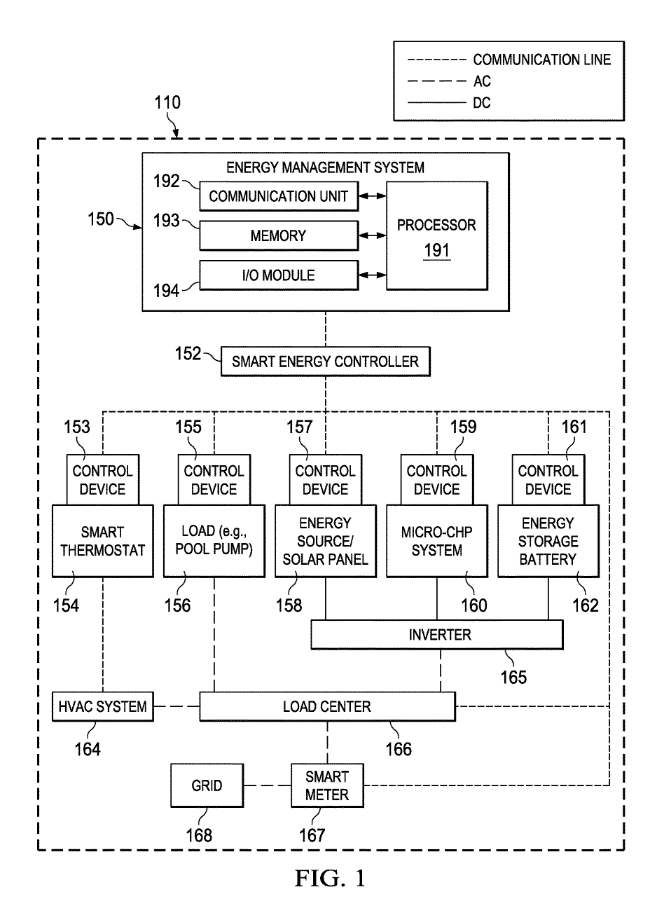

FIG. 1 presents an environment for performing energy management for an entity 110. The entity 110 may be a house. The entity 110 may comprise an energy management system 150, also referred to as the “system,” in communication with a smart energy controller 152. While the smart energy controller 152 is shown as being separate from the system 150, in alternate embodiments, the smart energy controller 152 may be included in the system 150. The smart energy controller 152 may be in communication with a control device 153 associated with a smart thermostat 154, a control device 155 associated with a load 156 such as a pool pump, a control device 157 associated with an energy source 158 such as a solar panel, a control device 159 associated with a micro combined heat and power (micro-CHP) system 160, a control device 161 associated with an energy storage 162 such as a battery, a load center 166, and a smart meter 167 connected to a grid 168 using an alternating current (AC) connection. The smart thermostat 154 may be in communication with a heating, ventilating, and air conditioning (HVAC) system 164. Any devices described as being in communication with each other may communicate with each other using any wired or wireless connection. An exemplary wired connection may be an Ethernet connection or a powerline communication (PLC) connection. An exemplary wireless connection may be a near field communication (NFC) connection, a Bluetooth connection, a Wi-Fi connection, a Wi-Fi peer-to-peer (P2P) connection, a Worldwide Interoperability for Microwave Access (WiMAX) connection, a ZigBee connection, etc. In some embodiments, any device in FIG. 1 may communicate with any other device in FIG. 1 even if the devices are not presented as being connected using a communication line.

The energy source 158, the micro-CHP system 160, and the energy storage 162 may be connected to an inverter 165 using a direct current (DC) connection. The HVAC system 164, the load 156, and the inverter 165 may be connected to the load center 166 using an AC connection. The load center 166 may be connected to the smart meter 167 using an AC connection. The smart meter 167 may be connected to the grid 168 using an AC connection. Energy may be transferred between any two devices that are connected using an AC or DC connection. Energy transfer on any DC connection between two devices may be unidirectional. Energy transfer on any AC connection between two devices may be bidirectional. In some embodiments, any device in FIG. 1 may transfer energy to any other device in FIG. 1 even if the devices are not presented as being connected using a DC or AC connection. In some embodiments, the entity 110 may include devices other than those presented in FIG. 1.

The system 150 may include components such as a processor 191, a communication unit 192, a memory 193, and an I/O module 194. Additional or alternative components other than those presented in FIG. 1 may be included in the system 150. The processor 191 may control any of the other components and/or functions performed by the various components in the system 150. Any actions described as being performed or executed by a processor may be performed or executed by the processor 191 alone or by the processor 191 in conjunction with one or more additional components. Additionally, while only one processor is shown, multiple processors may be present. Thus, while instructions may be described as being executed by the processor 191, the instructions may be executed simultaneously, serially, or otherwise, by one or multiple processors. The processor 191 may be implemented as one or more processing circuits and may be a hardware device capable of executing computer instructions. The processor 191 may execute instructions, codes, computer programs, or scripts. The instructions, codes, computer programs, or scripts may be received from the communication unit 192, the memory 193, or the I/O module 194.

Communication unit 192 may include one or more radio transceivers, chips, analog front end (AFE) units, antennas, processing units, memory, other logic, and/or other components to implement communication protocols (wired or wireless) and related functionality for communicating with the smart energy controller 152 or any other device (e.g., any control device) presented in FIG. 1. As a further example, communication unit 192 may include modems, modem banks, Ethernet devices, universal serial bus (USB) interface devices, serial interfaces, token ring devices, fiber distributed data interface (FDDI) devices, wireless local area network (WLAN) devices, Wi-Fi devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, WiMAX devices, and/or other devices for communication. Each of the various devices included in the communication unit 192 may include device-specific components or components (e.g., antennas) that are shared with other devices. As an example, a Wi-Fi device may share an antenna with a WiMAX device.

Memory 193 may include random access memory (RAM), read only memory (ROM), or various forms of secondary storage. RAM may be used to store volatile data and/or to store instructions that may be executed by the processor 191. For example, the data stored may be a command for controlling any of the devices presented in FIG. 1, a current operating state of the system 150, an intended operating state of the system 150, etc. ROM may be a non-volatile memory device that may have a smaller memory capacity than the memory capacity of a secondary storage. ROM may be used to store instructions and/or data that may be read during execution of computer instructions. Access to both RAM and ROM may be faster than access to secondary storage. Secondary storage may be comprised of one or more disk drives or tape drives and may be used for non-volatile storage of data or as an over-flow data storage device if RAM is not large enough to hold the data. Secondary storage may be used to store programs that may be loaded into RAM when such programs are selected for execution.

I/O module 194 may include liquid crystal displays (LCDs), touch screen displays, keyboards, keypads, switches, dials, mice, track balls, voice recognizers, card readers, paper tape readers, printers, video monitors, or other input/output devices. In some embodiments, the system 150 may be comprised in a computing device, a desktop computer, a laptop computer, a headless device (e.g., without a user interface), a mobile computing device (e.g., a mobile phone), a wearable computing device, or another suitable computing device.

The smart energy controller 152 may comprise hardware and/or software for communicating with and controlling the smart thermostat 154, the load 156, the energy source 158, the micro-CHP system 160, the energy storage 162, the load center 166, and the smart meter 167. The smart thermostat 154 may comprise hardware and/or software for communicating with and controlling an operational mode of the HVAC system 164. As an example, the smart energy controller 152 or the smart thermostat 154 may comprise a communication unit, a memory, an I/O module, and a processor similar to the communication unit 192, the memory 193, the I/O module 194, and the processor 191.

The HVAC system 164 may comprise components for heating, ventilating, and air-conditioning the entity 110. The load 156 may represent any energy consumption devices or activities. For example, the load 156 may represent a pool pump. The energy source 158 may comprise a device for absorbing or producing energy. For example, the energy source 158 may be a solar panel for absorbing energy from the sun. The micro-CHP system 160 may be a fuel cell or a heat engine that drives a generator which provides electrical energy and heat to the entity 110. The energy storage 162 may comprise a battery that can be charged, e.g., from the energy absorbed by the energy source 158 or from energy obtained from the grid 168, and discharged in order to supply energy to the load 156. In some embodiments, the HVAC system 164, the micro-CHP system 160, the energy source 158, the energy storage 162, and the smart meter 167 may also represent forms of load.

The load center 166 may facilitate the transfer of energy from one device to another device. For example, the load center 166 may comprise circuitry that facilitates transfer and distribution of energy from the grid 168 to the HVAC system 164, the load 156, the energy source 158, the micro-CHP system 160, and the energy storage 162. In some embodiments, the distribution of energy from the grid 168 to the various devices may be controlled by the smart energy controller 152 in communication with the load center 166. As a further example, the load center 166 may comprise circuitry that facilitates transfer of energy from the energy storage 162 to the grid 168. The inverter 165 may comprise circuitry for converting a DC signal associated with the energy source 158, the micro-CHP system 160, or the energy storage 162 to an AC signal. In some embodiments, the inverter 165 may be replaced with a converter that comprises circuitry for converting an AC signal associated with a device to a DC signal. The smart meter 167 may comprise circuitry for determining an amount of energy supplied by the grid 168 to the load center 166, or supplied to the grid 168 by the load center 166. The grid 168 may comprise a source of energy located outside the entity 110.

In an exemplary mode of operation, the system 150 and/or the smart energy controller 152 may transmit a command to a control device associated with the smart thermostat 154, the load 156, the energy source 158, the micro-CHP system 160, the energy storage 162, the load center 166, or the smart meter 167. The command may be a command to activate, deactivate, or change an operational mode of the smart thermostat 154, the load 156, the energy source 158, the micro-CHP system 160, the energy storage 162, the load center 166, or the smart meter 167. For example, changing an operational mode of the smart thermostat 154 may comprise changing an operational mode of the HVAC system 164 from a cooling mode to a heating mode. As a further example, activating or deactivating the energy source 158 may comprise activating or deactivating a mechanism for the energy source 158 to absorb energy from the sun. As a further example, activating or deactivating the energy storage 162 may comprise charging or discharging the energy storage 162. As a still further example, changing an operational mode of the load center 166 may comprise changing the distribution of energy to the various devices connected to the load center 166.

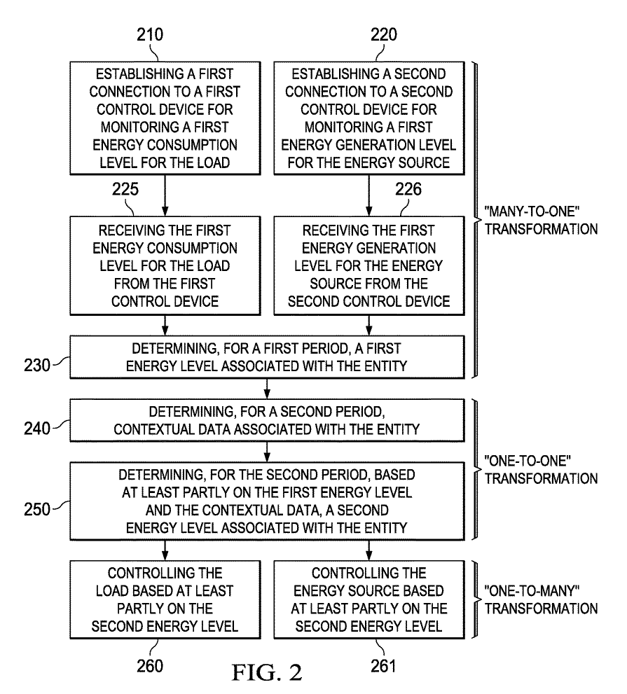

FIG. 2 presents a method for controlling a load (e.g., the load 156) and an energy source (e.g., the energy source 158) associated with an entity (e.g., the entity 110). As used in this disclosure, the term period may also refer to an instant of time. In some embodiments, the various blocks of the method may be performed by an energy management system such as the energy management system 150. At block 210, the method comprises establishing (e.g., from the smart energy controller 152 in communication with the energy management system) a first connection to a first control device (e.g., the control device 155) for monitoring a first energy consumption level for the load. At block 220, the method further comprises establishing (e.g., from the smart energy controller) a second connection to a second control device (e.g., the control device 157) for monitoring a first energy generation level for the energy source.

At block 225, the method further comprises receiving (e.g., at the energy management system) the first energy consumption level for the load from the first control device. At block 226, the method further comprises receiving (e.g., at the energy management system) the first energy generation level for the energy source from the second control device. At block 230, the method further comprises determining, for a first period, based at least partly on the first energy consumption level for the load and the first energy generation level for the energy source, a first energy level associated with the entity. The first period may be a period in the past (e.g., before a current time). Blocks 210 through 230 represent a “many-to-one” transformation because the energy consumption levels for one or more loads and the energy generation levels for one or more energy sources may be used to determine an energy level for a single entity.

At block 240, the method further comprises determining, for a second period, contextual data associated with the entity. The second period may be a period in the future (e.g., after the current time). Contextual data may comprise any data associated with the entity or a geographical area associated with the entity. For example, contextual data may comprise a weather forecast for a geographical area associated with the entity, a period of sunshine available to the energy source, a period of cloud cover associated with the energy source, a season, a particular time (e.g., a time of day, a day of the week or year, etc.), an occupancy of the entity, habits or activities associated with occupants of the entity, features associated with the entity (e.g., size of the entity, number of rooms in the entity, cost, type, and frequency of energy-related activities (e.g., energy-consumption activities, energy-generation activities, energy-storage activities, etc.) associated with the entity, number and types of energy sources, loads, and storages associated with the entity, etc.). The cost of energy consumption may, in some embodiments, be associated with a grid (e.g., the grid 168) or energy provider that provides energy to the entity. In some embodiments, contextual data at block 240 may be determined based on past trends (e.g., during the first period) of the contextual data. In some embodiments, occurrence of the contextual data may be associated with a probability. For example, when considering a weather forecast, the probability of rain in an area may be 50% for a particular period. In some embodiments, the method may also comprise determining contextual data for the first period in block 230, and then determining contextual data for the second period in block 240 based on the determined contextual data for the first period in block 230.

The method may further comprise determining an energy management program for the entity based on the determinations in blocks 230 and 240. At block 250, determining the energy management program may comprise determining, for the second period, based at least partly on the first energy level and the contextual data, a second energy level associated with the entity. The second energy level may comprise a second energy consumption level for the load and a second energy generation level for the energy source. Since the occurrence of the contextual data in block 240 is associated with a probability, the determined second energy level for the entity at block 250 may also be associated with a probability. Blocks 240 and 250 represent a “one-to-one” transformation because an energy level associated with a first period for a single entity may be used to determine an energy level associated with a second period for the single entity.

The energy management program may be stored in a memory (e.g., the memory 193) and executed by a processor (e.g., the processor 191). The energy management program may control, during the second period, one more energy-related activities associated with the entity. Energy-related activities may be associated with any of the devices presented in FIG. 1. For example, at block 260, the method further comprises controlling the load based on the second energy level or the second energy consumption level. The load may be controlled by transmitting control instructions to the control device (e.g., the control device 155) associated with the load. Therefore, the energy management program may determine when to activate or deactivate operation of the load, and a type of load selected for activation or deactivation.

Alternatively or additionally, at block 261, the method further comprises controlling the energy source based on the second energy level or the second energy generation level. The energy source may be controlled by transmitting control instructions to the control device (e.g., the control device 157) associated with the energy source. Therefore, the energy management program may determine when to activate and deactivate the energy source, and an amount of energy to generate using the energy source.

Additionally, in some embodiments, the method may further comprise controlling an energy storage (e.g., the energy storage 162). The energy storage may be controlled by transmitting control instructions to a control device (e.g., the control device 161) associated with the energy storage. Therefore, the energy management program may determine when to charge or discharge an energy storage associated with the entity. The energy storage may be charged using the energy source or the grid. In some embodiments, the energy management program may also determine whether to transmit excess energy back to the energy source or the grid from the energy storage. In some embodiments, controlling the load, the energy source, and the energy storage may comprise activating and/or deactivating the load, the energy source, and the energy storage for a certain period. Blocks 260 and 261 represent a “one-to-many” transformation because the energy level for a single entity may be used to control one or more loads, one or more energy sources, and/or one or more energy storages associated with the single entity. The various blocks of FIG. 2 may be executed in any order, and the order is not limited to the order described herein. Additionally, some blocks may be optional.

In some embodiments, the information determined in various parts of the method may be used to construct energy models or projections for future energy consumption and/or generation. For example, the method may comprise combining the contextual data for the first and second periods with the first energy level in block 230 and the second energy level in block 250 in order to derive energy models for the entity. Energy models may be used to determine relationships between a weather forecast and future energy generation levels, previous energy generation or consumption levels and future energy generation or consumption levels, time of day/day of week or year and future energy generation or consumption levels, etc.

As indicated previously, the determined energy level for the entity at block 250 may be associated with a probability. For example, the determined energy level (e.g., generation level, consumption level, etc.) for the second period may be associated with a probability of 60%. In some embodiments, an energy-related activity that is part of the energy management program may be selected based on a computation that comprises determining an expected utility associated with the activity, and maximizing the expected utility associated with the activity. The expected utility may be based on the determined energy level associated with the activity at block 250, and the probability associated with that determined energy level.

In embodiments where the entity is a house, the energy management program may be different for two similarly-sized houses. This may be because the contextual data (e.g., occupants' habits or activities, weather conditions, etc.) determined in block 240 may be different for each house. As another example, consider two houses with similar determinations for energy levels in block 230 and similar determinations (e.g., occupants' habits or activities, weather conditions, etc.) for contextual data in block 240. However, the contextual data for one of the houses has a much higher degree of variability (e.g., the occupants or the occupants' habits or activities change frequently, the weather conditions change frequently, etc.) compared to the other house. The higher variability in contextual data for one of the houses leads to a lower probability associated with the determination in block 240 compared to the determination in block 240 for the other house. Alternatively or additionally, the energy level determined in block 230 for one of the houses has a much higher degree of variability compared to the determination in block 230 for the other house. The higher variability of the energy level in block 230 for one of the houses leads to a lower probability associated with the determination in block 250 compared to the other house. In such an example, the energy management program determined may be different for both houses since the method described in this disclosure considers probabilities associated with the determinations in blocks 240 and 250.

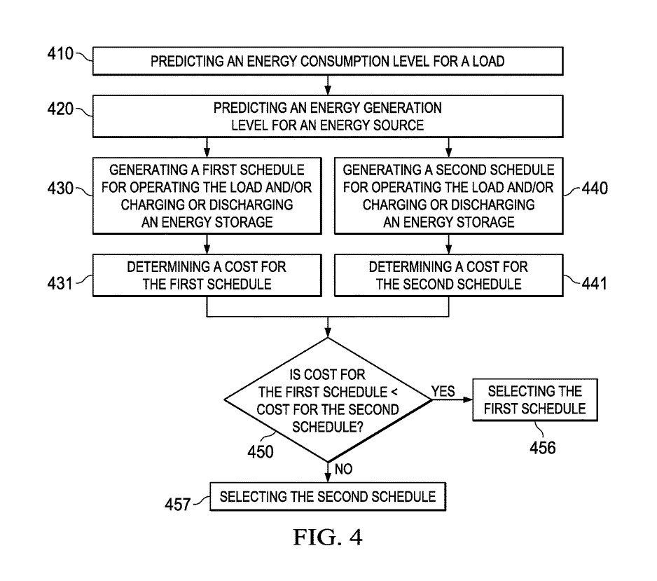

Any apparatus or device configured to perform the method of FIG. 2 or any other method such as FIG. 4 may comprise a communication unit (e.g., the communication unit 192), a memory (e.g., the memory 193), an I/O module (e.g., the I/O module 194), and a processor (e.g., the processor 191). The processor may be coupled to the I/O module, the memory, and the communication unit, and may be configured to perform the various methods described in this disclosure. Alternatively, the apparatus or device may comprise any suitable means to perform the various methods described in this disclosure. In some embodiments, a non-transitory computer readable medium is provided. The non-transitory computer readable medium may comprise code that when executed by one or more processors of an apparatus or device causes the apparatus or device to perform the various methods described in this disclosure.

Therefore, the present disclosure may be directed to transforming a past energy consumption level associated with a load and/or a past energy generation level associated with an energy source into a past energy level associated with the entity. The past energy level associated with the entity may be considered along with contextual data about the future to determine a future energy level associated with the entity. The future energy level associated with the entity may be used to control the load, the energy source, or the energy storage either during the present time or in the future.

In alternate embodiments, the past energy consumption level associated with the load may be considered along with contextual data about the future to determine a future energy consumption level associated with the load. The future energy consumption level associated with the load may be used to control the load either during the present time or in the future. Similarly, the past energy generation level associated with the energy source may be considered along with contextual data about the future to produce a future energy generation level associated with the energy source. The future energy generation level associated with the energy source may be used to control the energy source either during the present time or in the future. Finally, the past energy storage level associated with the energy storage may be considered along with contextual data about the future to produce a future energy storage level associated with the energy storage. The future energy storage level associated with the energy storage may be used to control the energy storage either during the present time or in the future.

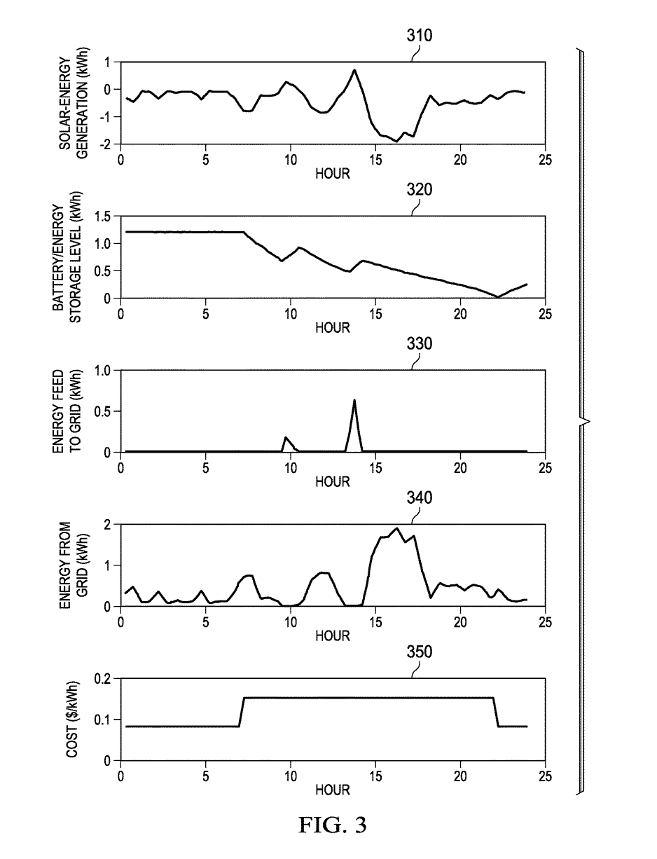

FIG. 3 presents charts associated with energy management for an entity (e.g., the entity 110). Chart 310 shows solar energy generation versus time. The solar energy may be generated using one or more energy sources (e.g., the energy source 158) associated with the entity 110. Chart 320 shows a battery level versus time. The battery level may be associated with an energy storage (e.g., the energy storage 162) that stores generated solar energy. The energy storage may store a limited amount of energy and can be used to power various energy-related activities associated with the entity. As indicated in chart 330, excess solar energy that cannot be stored in the energy storage due to the energy storage's limited capacity may be transmitted to a grid (e.g., the grid 168) that provides an alternate source of energy to the entity. Energy from the energy storage (chart 320) and the grid (chart 340) may be used in combination to provide energy to the load (e.g., the load 156) associated with the entity. For any particular load, an increase in the amount of energy used from the energy storage may cause a decrease in the amount of energy used from the grid, and vice versa. In some embodiments, certain types of load may require energy from the energy storage, and not from the grid, and vice versa. As indicated in chart 350, the cost of deriving energy from the grid may vary as a function of time. In order to make better energy decisions for the entity (e.g., based on the cost of deriving energy from the grid), there is a need to optimize the scheduling of various energy-related activities.

FIG. 4 presents a method for selecting among schedules for operating a load (e.g., the load 156) and an energy storage (e.g., the energy storage 162) associated with an entity (e.g., the entity 110). In some embodiments, the various blocks of the method may be performed by an energy management system (e.g., the energy management system 150). At block 410, the method comprises predicting an energy consumption level for the load for a future period. In some embodiments, the energy consumption level may be predicted based on a past or current energy consumption level for the load as determined by any control device (e.g., the control device 155) or combination of control devices described in this disclosure. Additionally, in some embodiments, the energy consumption level may be predicted based on any contextual data described in this disclosure.

At block 420, the method further comprises predicting an energy generation level for an energy source (e.g., the energy source 158) for a future period. In some embodiments, the energy generation level may be predicted based on a past or current energy generation level for the energy source as determined by any control device (e.g., the control device 157) or combination of control devices described in this disclosure. Additionally, in some embodiments, the energy generation level may be predicted based on any contextual data described in this disclosure.

At block 430, the method further comprises generating a first schedule for operating the load and/or charging or discharging the energy storage. At block 440, the method further comprises generating a second schedule for operating the load and/or charging or discharging the energy storage. A schedule may determine a starting time and/or an ending time for activating or deactivating the load, and/or charging or discharging the energy storage. The starting time and/or ending time for activating or deactivating the load, and/or charging or discharging the energy storage associated with the first schedule may be different from those associated with the second schedule. Additionally, the type of loads (e.g., pool pump, HVAC system, etc.) in operation during the first schedule may be different from the type of loads in operation during the second schedule.

At block 431, the method further comprises determining a cost for the first schedule. The cost may be associated with performing energy operations (e.g., energy transfer or energy usage operations) associated with the load, the energy storage, the energy source, or the grid (e.g., the grid 168). An exemplary energy transfer operation may be the transfer of energy from the grid to the load. An exemplary energy usage operation may be activation of the load. At block 441, the method further comprises determining a cost for the second schedule.

At block 450, the method further comprises determining whether a cost for the first schedule is less than a cost for the second schedule. If the cost for the first schedule is less than the cost for the second schedule, the method, at block 456, further comprises selecting the first schedule. If the cost for the first schedule is not less than the cost for the second schedule, the method, at block 457, further comprises selecting the second schedule. The various blocks of FIG. 4 may be executed in any order, and the order is not limited to the order described herein. Additionally, some blocks may be optional. While the exemplary method in FIG. 4 describes a process for selecting between two schedules, the method may be extended to select between any number of schedules.

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used in this disclosure have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings in this disclosure are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings in this disclosure.

What is claimed is:

1. A method for controlling a load and an energy source associated with an entity, the method comprising:
establishing a first connection to a first control device for monitoring a first energy consumption level for the load;
establishing a second connection to a second control device for monitoring a first energy generation level for the energy source;
receiving the first energy consumption level for the load from the first control device;
receiving the first energy generation level for the energy source from the second control device;
determining, for a first period, based at least partly on the first energy consumption level for the load and the first energy generation level for the energy source, a first energy level associated with the entity;
determining, for a second period, a contextual data associated with the entity;
determining, for the second period, based at least partly on the first energy level and the contextual data, a second energy level associated with the entity; and
at least one of:
controlling the load based at least partly on the second energy level; and
controlling the energy source based at least partly on the second energy level.

2. The method of claim 1, wherein controlling the load comprises activating or deactivating the load for a first predetermined period, and wherein controlling the energy source comprises activating or deactivating the energy source for a second predetermined period.

3. The method of claim 1, wherein the first period occurred prior to a present time, and wherein the second period will occur after the present time.

4. The method of claim 1, wherein determining the first energy level comprises determining a variability in the first energy level.

5. The method of claim 1, wherein determining the contextual data comprises determining a variability in the contextual data.

6. The method of claim 1, wherein the second energy level comprises a second energy consumption level for the load and a second energy generation level for the energy source, wherein the load is controlled based at least partly on the second energy consumption level, and wherein the energy source is controlled based at least partly on the second energy generation level.

7. The method of claim 1, further comprising communicating with the load, the energy source, and an energy storage.

8. The method of claim 1, wherein the determination of the contextual data is based at least partly on monitoring entity data associated with the entity during the first period.

9. The method of claim 8, wherein the entity data comprises at least one member from the group consisting of a weather forecast for an area associated with the entity, a number of occupants in the entity, energy-related activities of the occupants in the entity, a type, cost, and usage of loads associated with the entity, a type, cost, and usage of energy sources associated with the entity, and a type, cost, and usage of energy storages associated with the entity.

10. The method of claim 1, further comprising:
predicting a second energy consumption level for the load; and
predicting a second energy generation level for the energy source.

11. The method of claim 10, further comprising:
generating, based at least partly on the second energy consumption level for the load and the second energy generation level for the energy source, a first schedule and a second schedule for operating the load and charging or discharging an energy storage.

12. The method of claim 11, further comprising:
determining a first energy cost for the first schedule and a second energy cost for the second schedule;
determining the first energy cost is lower than the second energy cost; and
selecting the first schedule.

13. An apparatus for controlling a load and an energy source associated with an entity, the apparatus comprising:
a communication unit configured to:
receive a first energy consumption level for the load from a first control device for monitoring a first energy consumption level for the load, and
receive a first energy generation level for the energy source from a second control device for monitoring a first energy generation level for the energy source;
a memory; and
a processor, coupled to the memory, and configured to:
determine, for a first period, based at least partly on the first energy consumption level for the load and the first energy generation level for the energy source, a first energy level associated with the entity;
determine, for a second period, a contextual data associated with the entity;
determine, for the second period, based at least partly on the first energy level and the contextual data, a second energy level associated with the entity; and
at least one of:
control the load based at least partly on the second energy level; and
control the energy source based at least partly on the second energy level.

14. The apparatus of claim 13, wherein the first period occurred prior to a present time, and wherein the second period will occur after the present time.

15. The apparatus of claim 13, wherein determining the first energy level comprises determining a variability in the first energy level.

16. The apparatus of claim 13, wherein determining the contextual data comprises determining a variability in the contextual data.

17. The apparatus of claim 13, wherein the second energy level comprises a second energy consumption level for the load and a second energy generation level for the energy source, wherein the load is controlled based at least partly on the second energy consumption level, and wherein the energy source is controlled based at least partly on the second energy generation level.

18. The apparatus of claim 13, wherein the processor is further configured to communicate with the load, the energy source, and an energy storage.

19. The apparatus of claim 13, wherein the determination of the contextual data is based at least partly on monitoring entity data associated with the entity during the first period.

20. The apparatus of claim 19, wherein the entity data comprises at least one member from the group consisting of a weather forecast for an area associated with the entity, a number of occupants in the entity, energy-related activities of the occupants in the entity, a type, cost, and usage of loads associated with the entity, a type, cost, and usage of energy sources associated with the entity, and a type, cost, and usage of energy storages associated with the entity.

21. The apparatus of claim 13, wherein the processor is further configured to:
predict a second energy consumption level for the load; and
predict a second energy generation level for the energy source.

22. The apparatus of claim 21, wherein the processor is further configured to generate, based at least partly on the second energy consumption level for the load and the second energy generation level for the energy source, a first schedule and a second schedule for operating the load and charging or discharging an energy storage.

23. The apparatus of claim 22, wherein the processor is further configured to:
determine a first energy cost for the first schedule and a second energy cost for the second schedule;
determine the first energy cost is lower than the second energy cost; and
select the first schedule.

24. An apparatus for controlling a load and an energy source associated with an entity, the apparatus comprising:
means for establishing a first connection to a first control device for monitoring a first energy consumption level for the load;
means for establishing a second connection to a second control device for monitoring a first energy generation level for the energy source;
means for receiving the first energy consumption level for the load from the first control device;
means for receiving the first energy generation level for the energy source from the second control device;
means for determining, for a first period, based at least partly on the first energy consumption level for the load and the first energy generation level for the energy source, a first energy level associated with the entity;
means for determining, for a second period, a contextual data associated with the entity;
means for determining, for the second period, based at least partly on the first energy level and the contextual data, a second energy level associated with the entity; and
at least one of:
means for controlling the load based at least partly on the second energy level; and
means for controlling the energy source based at least partly on the second energy level.

25. The apparatus of claim 24, further comprising:
means for predicting a second energy consumption level for the load;
means for predicting a second energy generation level for the energy source;
means for generating, based at least partly on the second energy consumption level for the load and the second energy generation level for the energy source, a first schedule and a second schedule for operating the load and charging or discharging an energy storage;
means for determining a first energy cost for the first schedule and a second energy cost for the second schedule;
means for determining the first energy cost is lower than the second energy cost; and
means for selecting the first schedule.

26. A non-transitory computer readable medium for controlling a load and an energy source associated with an entity, the non-transitory computer readable medium comprising code, the code, when executed by one or more processors of a computing device, causes the computing device to:
receive a first energy consumption level for the load from a first control device;
receive a first energy generation level for the energy source from a second control device;
determine, for a first period, based at least partly on the first energy consumption level for the load and the first energy generation level for the energy source, a first energy level associated with the entity;
determine, for a second period, a contextual data associated with the entity;
determine, for the second period, based at least partly on the first energy level and the contextual data, a second energy level associated with the entity; and
at least one of:
control the load based at least partly on the second energy level; and
control the energy source based at least partly on the second energy level.

27. The non-transitory computer readable medium of claim 26, wherein determining the first energy level comprises determining a variability in the first energy level, and determining the contextual data comprises determining a variability in the contextual data.

28. The non-transitory computer readable medium of claim 26, wherein the code, when executed by the one or more processors of the computing device, further causes the computing device to communicate with the load, the energy source, and an energy storage.

29. The non-transitory computer readable medium of claim 26, wherein the contextual data comprises at least one member from the group consisting of a weather forecast for an area associated with the entity, a number of occupants in the entity, energy-related activities of the occupants in the entity, a type, cost, and usage of loads associated with the entity, a type, cost, and usage of energy sources associated with the entity, and a type, cost, and usage of energy storages associated with the entity.

30. The non-transitory computer readable medium of claim 26, wherein the code, when executed by the one or more processors of the computing device, further causes the computing device to:
predict a second energy consumption level for the load;
predict a second energy generation level for the energy source;
generate, based at least partly on the second energy consumption level for the load and the second energy generation level for the energy source, a first schedule and a second schedule for operating the load and charging or discharging an energy storage;
determine a first energy cost for the first schedule and a second energy cost for the second schedule;
determine the first energy cost is lower than the second energy cost; and
select the first schedule.
